(19) United States
(12) Patent Application Publication
(10) Pub. No.: US 2026/0048942 A1
(43) Pub. Date: Feb. 19, 2026

(54) FOAM DELIVERY CHUTE

(71) Applicant: Western States Fire Inc., San Diego, CA (US)

(72) Inventors: Wesley Chau, San Diego, CA (US); Raymond Constantine, San Diego, CA (US); Eder Landgrave, San Diego, CA (US); Juan Ramirez, San Diego, CA (US)

(21) Appl. No.: 19/275,872

(22) Filed: Jul. 21, 2025

Related U.S. Application Data
(60) Provisional application No. 63/673,696, filed on Jul. 20, 2024.

(51) Int. Cl. B65G 11/08; A62C 3/02; B64D 1/16

(52) U.S. Cl. CPC B65G 11/083; A62C 3/0228; B64D 1/16

(57) ABSTRACT

A foam delivery chute to improve the aerial firefighting process of dropping fire suppressant foam onto fires. The chute is made up of fire-resistant material arranged in a Kresling pattern and designed to provide a guide for the fire suppressant foam. This results in much more accurate delivery of foam, thus making the entire process much more efficient and accurate. The chute is extended or retracted by a mechanical shaft system and is operated by the pilot of the aerial vehicle.

### RELATED APPLICATIONS

This application claims priority to U.S. Provisional Patent Application Ser. No. 63/673,696 entitled “Foam Delivery Chute,” filed Jul. 20, 2024, and currently co-pending, the entirety of which is fully incorporated herein by reference.

### FIELD OF THE INVENTION

The present invention pertains generally to apparatus for use in fire suppression. More particularly, the present invention pertains to a foam delivery chute for the use in aerial fire suppression. The present invention is particularly, but not exclusively, useful as a chute to deliver foam in a more efficient manner.

### BACKGROUND OF THE INVENTION

A perennial problem in aerial firefighting systems is the inefficiency surrounding the delivery process of fire suppressant foam when being used to extinguish a fire. The current process involves an airplane, or helicopter, simply flying over a fire and then dumping foam onto the fire in hopes that it reaches the fire. Consequently, the result is a process that is incredibly inefficient.

There are several different factors that contribute to the inefficiencies. Depending on the scenario, the total time for the foam to drop onto the ground from the aerial vehicle ranges from three to thirty seconds. During this time, the foam suppressant gains a tremendous amount of velocity and kinetic energy that is sprayed out without any guidance system. Compounding the problem is that the foam is subject to wind forces and any other air disturbances caused by the aerial vehicle. This results in a “shotgun approach” for delivering the foam that is incredibly inaccurate. It is estimated that probably 40% to 60% of the foam suppressant misses the target and is not nearly as effective as it could be.

The current process is also incredibly expensive. The aerial vehicle can only perform one pass at a time before needing to land in order to have more foam suppressant loaded and increasing both the amount of foam needed and the costs associated with it. There are also unnecessarily high fuel costs associated with the current process. For each extra trip that is made to deliver foam, more fuel is burned as the aerial vehicle travels back and forth. A reduction in the number of trips needed will also result in lower fuel costs to fight the same fire.

The expense and inefficiency in delivery has created a need in the art for a system that is much more accurate in delivering fire suppressant foam at a lower cost.

### SUMMARY OF THE INVENTION

Disclosed is a foam delivery chute that is collapsible, low cost, and able to accurately deliver fire suppressant foam over a targeted area. Preferred embodiments of the foam delivery chute have a targeted opening and deliver foam through the targeted opening. The targeted opening of the chute allows for an accurate delivery of fire suppressant foam because it provides a path for the foam to follow before being exposed to the elements. As such, the present invention greatly improves the aerial firefighting technique of using fire suppressant foam because it provides a targeted approach instead of the shotgun approach currently used.

The main component of the present invention is the chute itself. Its design was based on a Kresling Structure which will allow the chute to repeatedly extend and retract without compromising structural integrity over time. The exterior of the chute is made up of a lightweight fire-resistant material that encases individual triangles that are cut out of either aluminum, carbon fiber or any other material known in the art. The combination of these different materials ensures that the chute is lightweight and is able to perform effectively while also maintaining its structural integrity.

In preferred embodiments, a base plate is attached to the bottom of the chute and the top of the chute is attached to a top plate. The top plate also houses a shaft system that is responsible for the movement of the chute itself. The shaft system is responsible for the extension or retraction of the chute in a quick manner to meet the needs of any given situation. A preferred embodiment of the shaft system is made up of one motor, two shafts, and chains that connect the motor and shafts together. The two shafts are mounted onto either side of the chute opening. The first chain is connected to the motor and the first shaft, and the second chain is connected to both shafts so that the entire system moves in unison.

The present invention thus provides a foam delivery chute that is lightweight and provides a targeted approach to the process of delivering fire suppressant foam onto a fire.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a right-side view of a preferred embodiment of the foam delivery chute fully extended;

FIG. 2 is a bottom-right perspective view of a preferred embodiment of the foam delivery chute fully retracted;

FIG. 3 is a top view of a preferred embodiment of the foam delivery chute showing the shaft system, motor, and chute opening;

FIG. 4 is a bottom view of a preferred embodiment of the bottom plate mounted onto the bottom of the foam delivery chute;

FIG. 5 is a top view showing different embodiments for the triangles that make up the Kresling Structure;

FIG. 6 is a top view of a preferred embodiment of the chute with the preferred layout for the Kresling Structure;

FIG. 7 is a top view of an alternative embodiment of the chute with an alternative layout for the Kresling Structure that increases the diameter of the chute opening;

FIG. 8 is a side-by-side comparison of different patterns for the Kresling structure that make up the chute;

FIG. 9 is a side view of an alternative embodiment of the chute partially constructed.

### DETAILED DESCRIPTION

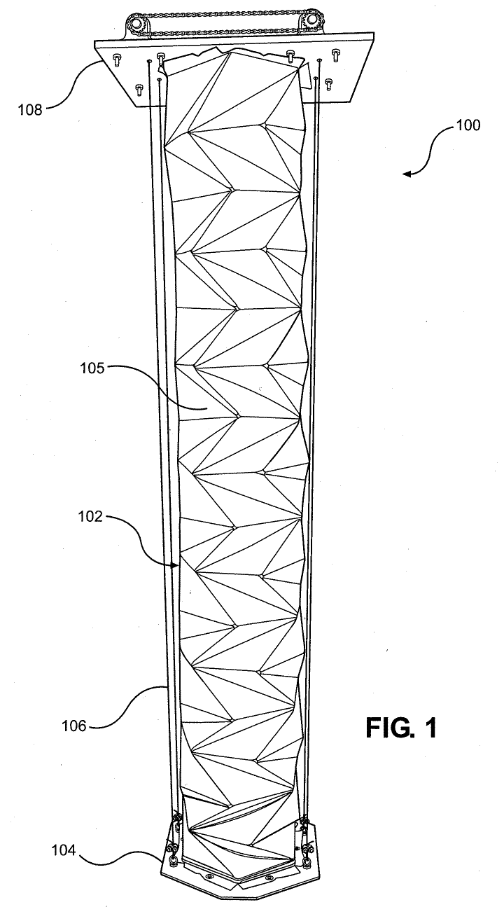

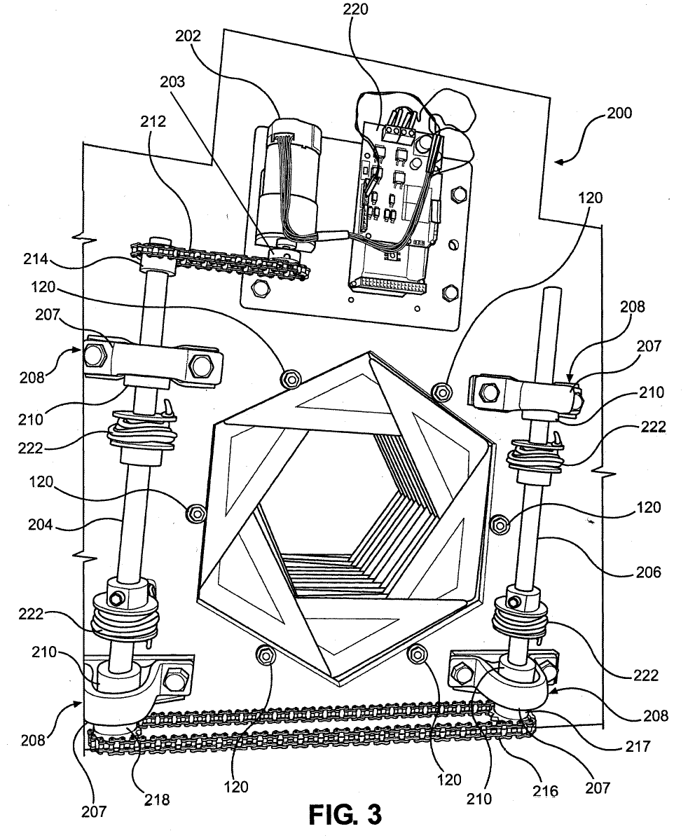

Referring initially to FIG. 1 a side view of foam delivery chute assembly is illustrated and generally designated 100. Assembly 100 is lightweight, easy to transport, and cost effective. Assembly 100 includes chute 102, manufactured out of lightweight and flame-resistant materials, while the shaft system 200 as shown in FIG. 3 is responsible for the extension and retraction of chute 102 and has a small equipment footprint. Therefore, the entire system can be installed on a wide variety of different aircraft. It is also fully envisioned that alternative embodiments can be made to meet the specific needs of any given situation. Thus, there is a tremendous amount of flexibility for the design of the system and its applications.

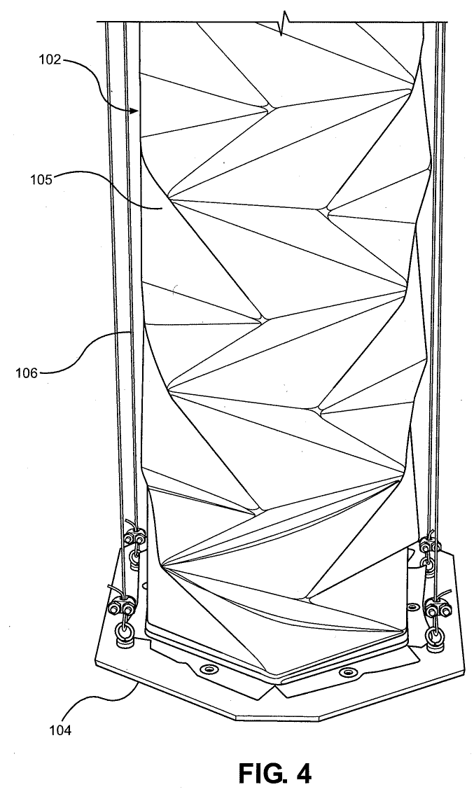

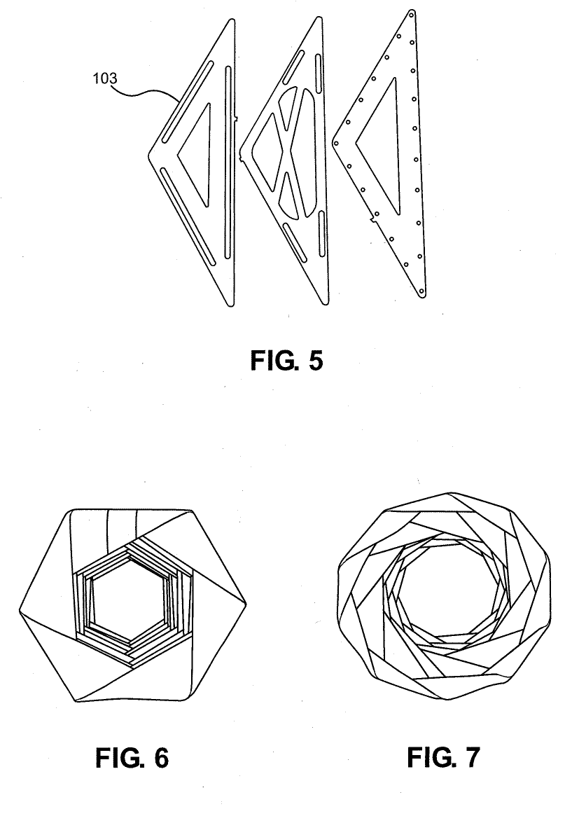

In FIG. 1, chute 100 is shown in a fully extended configuration, in which the Kresling Structure making up chute 102 is clearly visible. Preferred embodiments of chute 102 are made up of two different components, an exterior cloth 105 that encases the individual triangles 103 and the individual triangles 103 (shown in FIG. 5) that form the Kresling Structure. In a preferred embodiment, the material covering triangles 103 is a silicone rubber coated fiberglass cloth. This cloth is flexible, lightweight, and fire resistant. In addition, the cloth is not prone to creasing caused by repeated extension or retraction of chute 102. This allows the exterior cloth to maintain its structural integrity over a long period of time. Other materials currently available in the art that would be suitable substitutes for the silicone rubber coated fiberglass cloth are fully contemplated and incorporated herein.

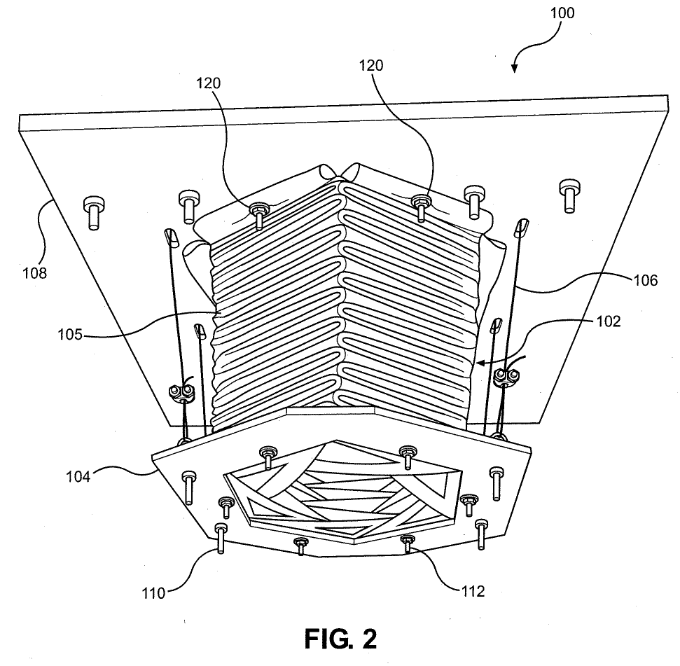

Triangles 103 are also lightweight and flame resistant. Triangles 103 are designed to fold in a specific manner so that there is sufficient rigidity throughout the entire chute 102 when fully extended, but they also provide sufficient flexibility so that chute 102 can retract when foam delivery chute 100 is not in use (as shown in FIG. 2). In a preferred embodiment triangle 103 is cut out off a lightweight and flame-resistant material like aluminum or carbon fiber. However, other materials that are known in the art that can meet the design requirements for triangle 103 are fully contemplated and incorporated herein.

Attached to the bottom of chute 102 is bottom plate 104. Bottom plate 104 will also be constructed of a lightweight and flame-resistant material such as aluminum or carbon fiber, but any other material known in the art to meet these requirements are fully contemplated and incorporated herein. Bottom plate 104 is the part of foam delivery chute 100 that allows chute 102 to extend or retract. This is achieved in part to cables 106 that are connected to the top of bottom plate 104, and shaft system 200 (shown in FIG. 3).

The top of chute 102 is connected to the bottom surface of top plate 108, while the top surface of top plate 108 has shaft system mounted on top. In addition to serving as the base for shaft system 200, it also allows foam delivery chute 100 to be easily installed onto existing foam delivery systems.

Referring now to FIG. 2, a bottom perspective view of foam delivery chute 100 in its fully retracted configuration is shown. The Kresling Structure making up chute 102 is shown fully compressed with triangles 103 (shown in FIG. 5) folded on top of each other. This results in a significant decrease in the overall size of chute 102. There are different mounting mechanisms for chute 102 and cables 106 so that each component can be fixed to bottom plate 104 is shown. There are six different chute fasteners 112 that are located in different positions so that chute 102 is mounted flush to the top surface 104. Additionally, there are four different cable fasteners 110 that are located to ensure uniform movement of chute 102, regardless of whether chute 102 is extending or retracting.

As shown in FIG. 2, the chute 102 is shown in a retracted configuration in which the exterior cloth 105 that encases the individual triangles 103 and the individual triangles 103 (shown in FIG. 5) that form the Kresling Structure are compressed together to substantially shorten chute 102. This shortening of chute 102 is accomplished through retraction or deployment of cables 106.

Referring now to FIG. 3, a top view of foam delivery chute 100 is shown. From this view, the opening of chute 102 is on display and was sized to facilitate the delivery of foam in an efficient manner when fully extended. To secure chute 102 to the bottom surface of top plate 108, six chute bolts 120 were placed around the top surface of top plate 108. These bolts secure chute 102 to top plate 108, and while bolts are currently envisioned, it is not intended to be a limiting example as other fastening means known in the art are fully contemplated herein.

Of particular note for this view is shaft assembly 200, which is responsible for the movement of chute 102. Preferred embodiments of shaft assembly 200 have a number of components, but start with the operation of control system 220 and electric motor 202. Control system 220 is programmed to control electric motor 202 based on input it receives from the pilot of the aerial vehicle, or whoever is responsible for overseeing the aerial delivery of fire suppressant foam. In a preferred embodiment, electric motor 202 is a DC motor that has the ability to rotate in a clockwise or counterclockwise direction, depending on the voltage input it receives from control system 220. Moreover, electric motor 202 is sufficiently powerful to ensure that it can handle the weight of chute 102 in an efficient manner.

To help facilitate efficient operation, electric motor 202 is connected to first chain 212 via motor sprocket 203. As motor sprocket 203 turns, it will transfer that motion to first chain 212 which in turn will cause first shaft 204 to rotate. This movement is achieved because first chain 212 is also connected to driver socket 214. Driver socket 214 is attached to the proximal end of first shaft 204, causing it to rotate in a direction that is dependent on the rotation of electric motor 202. As first shaft 204 rotates, second shaft 206 will also rotate in a manner that ensures uniform extension or retraction of chute 102. The rotation of second shaft 206 is made possible due to first shaft socket 218 that is attached to the distal end of first shaft 204, and second shaft socket 217 located on the distal end of second shaft 206. Second chain 216 wraps around both first shaft socket 218 and second shaft socket 217 so that both first shaft 204 and second shaft 206 move in unison with each other.

First shaft 204 and second shaft 206 are mounted on the top surface of top plate 108 by bearing assembly 208. Bearing assembly 208 is made up of u-bracket 207 and bearing 210. Bearing 210 is what allows both shafts to rotate freely while fully supported. In total there are four different bearing assemblies 208, with one located close to the proximal end of each shaft, and one located close to the distal end of each shaft. There are also two different cable storage systems 222 that encase and rotate with each shaft. Cable storage system 222 is where cables 106 are stored. All four cable storage systems, two per shaft, move in unison with the corresponding shaft it is mounted onto. Cables 106 are initially installed onto cable storage system 222 to ensure that they do not tangle so that cables 106 can operate as intended.

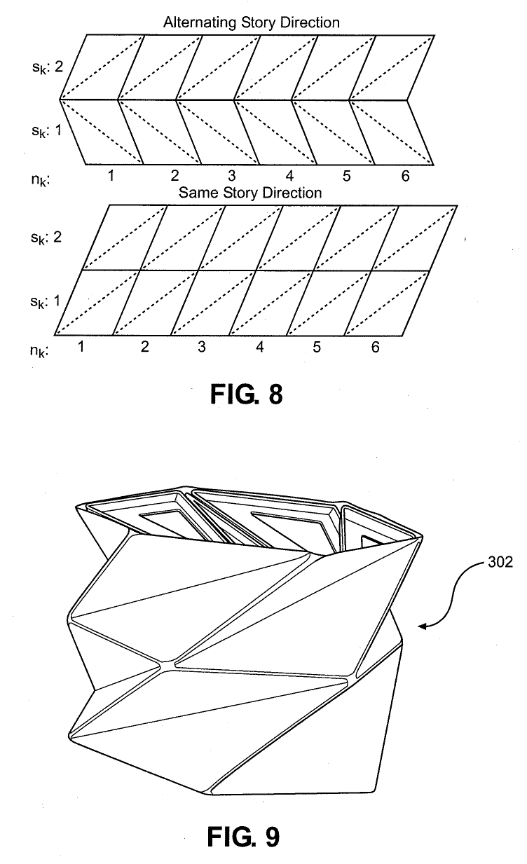

Referring now to FIG. 4 a close-up view of a fully assembled chute 102 is shown. The benefit of the Kresling Structure is it is a naturally folding pattern that occurs during the buckling of thin-walled cylindrical bodies such as chute 102. By using an alternating pattern for the Kresling Structure, the cabling system is better accommodated (see FIG. 8 for different pattern configurations). The alternate pattern used also provides increased convenience to the overall system. The current structure of chute 102 allows it to collapse in a uniform manner and is not subject to the rotational forces that a same direction pattern would cause. With this pattern chute 102 is able to collapse up to 93% of its extended length. Thus, letting the entire foam delivery chute 100 to be easily transported, installed, or swapped between different aerial vehicles.

Referring now to FIG. 5, different embodiments of the individual triangle 103 that make up the kresling structure of chute 102 are shown. All three of the different triangles 103 can be used, since the different hole and slot configurations are for stitching purposes. The particular angles used in the design of triangles 103 has a significant impact on the effectiveness and reliability of chute 102. In preferred embodiments, each triangle 103 is composed of two 30° angles, and one 120° angle. This design allows for the maximum amount of collapsibility while still maintaining structural integrity of chute 102. As mentioned earlier, each individual triangle 103 is also lightweight and fire resistant. In a preferred embodiment each triangle 103 is machined out of aluminum, however other materials such as carbon fiber and other materials known in the art that achieve similar results are fully contemplated herein.

Referring now to FIGS. 6 and 7, the different diameters for chute 102 are shown. Each of the different chutes 102 in FIGS. 6 and 7 have different internal diameters. This is caused by the different polygon that serves as the basis for the chute. As the number of sides in the polygon goes up, the wider the interior diameter of chute 102 ends up being. With a larger diameter, the more foam suppressant that can be delivered. However, with each side of the polygon that is added, it results in more parts making up each chute 102; resulting in a more complex chute that needs to be manufactured that is also more expensive to make. In a preferred embodiment, the ideal polygon to serve as the basis of chute 102 is a hexagon. A hexagon allows for the greatest amount of fire suppressant foam to be delivered in the most cost-effective way. However, chute 102 with additional sides, such as the decagon in FIG. 7, to create larger interior diameters to accommodate the delivery of larger quantities of fire suppressant foam are fully envisioned in alternate embodiments of foam delivery chute 100.

Referring now to FIG. 8, a side-by-side comparison of the different patterns for the Kresling structure are shown. In a preferred embodiment the alternating story direction is used as particularly suitable to the operation and design of shaft system 200. The same story direction pattern results in a twisting motion when chute 102 is either extended or retracted.

Referring now to FIG. 9, an alternate embodiment of the chute is illustrated and generally designated 302. Like chute 102 (see FIGS. 1-4), chute 302 is organized in a hexagonal pattern. However, chute 302 is folded in a same story direction so that it appears to twist in a helical form from the side, as opposed to the alternating direction of the folds in chute 102 (see FIG. 4).

While there have been shown what are presently considered to be preferred embodiments of the present invention, it will be apparent to those skilled in the art that various changes and modifications can be made herein without departing from the scope and spirit of the invention.

What is claimed is:

1. A foam delivery system comprising:
a chute having a top end a bottom end;
a top plate located on the top end of the chute;
a bottom plate located on the bottom end of the chute; and
a plurality of cables that are connected to the bottom plate and the shaft system.

2. The foam delivery system of claim 1, wherein the chute further comprises an exterior portion that is made up of a cloth and an interior portion that is made up of a plurality of triangles.

3. The foam delivery system of claim 2, wherein the plurality of triangles form a structure to allow the chute to easily extend and retract.

4. The foam delivery system of claim 3, wherein the chute further comprises a hollow interior of variable length that runs from the top end of the chute to the bottom end of the chute.

5. The foam delivery system of claim 4, wherein the top plate further comprises a top side and a bottom side.

6. The foam delivery system of claim 5, further comprising a shaft system located on the top side of the top plate that controls the extension and retraction of the chute.

8. The foam delivery system of claim 6, wherein the shaft system further comprises a control system, a first rod attached to the top side of the top plate and located on a side of the opening of the chute that is in mechanical communication with a second rod that is on an opposite side of the opening of the chute, and an electric motor that is in mechanical communication with the first rod.

8. A foam delivery system comprising:
a chute having a hollow interior, a top end, and a bottom end;
a top plate having a top side and a bottom side that is connected to the top end of the chute;
a bottom plate having a top side that is connected to the bottom end of the chute and a bottom side;
a shaft system located on the top side of the top plate; and
a plurality of cables that are connected to the shaft system and the top side of the bottom plate,
wherein the shaft system is configured to extend or retract the chute.

9. The foam delivery system of claim 8, wherein the chute further comprises an opening at the top end and the bottom end.

10. The foam delivery system of claim 9, wherein the shaft system further comprises a control system, a first rod attached to the top side of the top plate and located on a side of the opening of the chute that is in mechanical communication with a second rod that is on an opposite side of the opening of the chute, and an electric motor that is in mechanical communication with the first rod.

11. The foam delivery system of claim 10, wherein the chute further comprises an exterior portion that is made up of a cloth and an interior portion that is made up of a plurality of triangles.

12. The foam delivery system of claim 11, wherein the plurality of triangles form a structure to allow the chute to easily extend and retract.

13. A foam delivery system comprising:
a flexible chute of variable length having a first opening at a first end and a second opening at a second end;
a top plate having a top side and a bottom side attached to the first opening of the flexible chute;
a bottom plate having a top side connected to the second end of the flexible chute and a bottom side; and
a shaft system located on the top side of the top plate that is configured to extend and retract the flexible chute.

14. The foam delivery system of claim 13, wherein the shaft system further comprises a control system, a first rod attached to the top side of the top plate and located on a side of the opening of the chute that is in mechanical communication with a second rod that is on an opposite side of the opening of the chute, and an electric motor that is in mechanical communication with the first rod.

15. The foam delivery system of claim 14 further comprising a plurality of cables that are evenly distributed between the first rod and the second rod and are connected to the top side of the bottom plate.

16. The foam delivery system of claim 15, wherein the flexible chute further comprises an exterior portion that is made up of a cloth and an interior portion that is made up of a plurality of triangles.

17. The foam delivery system of claim 16, wherein the plurality of triangles form a structure to allow the chute to easily extend and retract.

18. The foam delivery system of claim 17, wherein the first opening and the second opening of the flexible chute form a hexagon.

19. The foam delivery system of claim 17, wherein the first opening and the second opening of the flexible chute form a decagon.
